(19) United States
(12) Patent Application Publication
(10) Pub. No.: US 2013/0166395 A1
(43) Pub. Date: Jun. 27, 2013

(54) SYSTEM AND METHOD FOR CREATING A DELIVERY ALLOCATION PLAN IN A NETWORK-BASED ENVIRONMENT

(71) Applicants: Sergei Vassilvitskii, New York, NY (US); Chandrashekhar Nagarajan, Santa Clara, CA (US); Peiji Chen, San Jose, CA (US); Jian Yang, Palo Alto, CA (US); John Tomlin, Sunnyvale, CA (US); Vijay Bharadwaj, Belmont, CA (US); Erik Vee, San Mateo, CA (US); WenJing Ma, Sunnyvale, CA (US)

(72) Inventors: Sergei Vassilvitskii, New York, NY (US); Chandrashekhar Nagarajan, Santa Clara, CA (US); Peiji Chen, San Jose, CA (US); Jian Yang, Palo Alto, CA (US); John Tomlin, Sunnyvale, CA (US); Vijay Bharadwaj, Belmont, CA (US); Erik Vee, San Mateo, CA (US); WenJing Ma, Sunnyvale, CA (US)

(21) Appl. No.: 13/333,241

(22) Filed: Dec. 21, 2011

(51) Int. Cl. G06Q 30/02

(52) U.S. Cl. 705/14.73; 705/14.4

(57) ABSTRACT

The present application provides systems and corresponding methods for creating a delivery allocation plan in a network-based environment. The methods may include receiving and storing advertising contracts and data related to the advertising contracts; constructing a bipartite graph based on the received contract data; annotating each demand node; and receiving impression data and other eligible contract data. Thereafter, the method may include for each impression, calculating a first supply value and for each contract, calculating a first demand value. The first demand value may be used to calculate a second supply value and a delivery allocation may be calculated using the second supply value and the second demand value for each contract.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present application relates generally to ad serving, more specifically to the optimization of allocation plans for delivering advertisements in a network-based environment.

### BACKGROUND OF THE INVENTION

Since the widespread acceptance of the Internet, advertising as a main source of revenue has proven to be both effective and lucrative. Advertising on the Internet provides the additional benefit of allowing advertisers to more effectively target audiences viewing their advertisements as opposed to traditional print and “hard copy” advertising which constitute a one-way flow of information: advertisers to users.

The very nature of the Internet facilitates a two way flow of information between users and advertisers and allows these transactions to be conducted in real time or near-to-real time. For example, a user may request an ad and may intentionally, or inherently, transmit various pieces of data describing himself or herself. Additionally, an advertising management system may be able to intelligently determine which ads to place on a given website requesting advertisement content, increasing the revenue for both parties involved and increasing user satisfaction by eliminating “nuisance” ads, or those ads in which a user is not interested.

The current state of the art, however, fails to fully exploit the interactive aspects of the Internet in the advertising realm. Most current advertising systems need to coordinate a number of components, such as components for forecasting web traffic, targeting demographics, procuring ad placements, and publishing ads. Each component relies on the cooperative and reliable performance of the others. Unfortunately, current advertising systems are decoupled. A decoupled system results in a number of inconsistencies with respect to contracts for the placement and delivery of advertisements. Even just a slight overestimation of future web traffic may jeopardize an advertising system's ability to deliver the advertisements promised. Likewise, an underestimation hurts advertisers and publishers alike because of lost opportunities for ad placements.

Current systems create a strict and artificial separation between display inventory of available advertisement placements that is sold many months in advance in a guaranteed fashion (guaranteed delivery), and inventory that is sold in a real-time auction, in a market, or through other means (non-guaranteed delivery). For instance, the Yahoo!® advertising system may serve guaranteed contracts their desired quota before serving non-guaranteed contracts, creating an unnecessary and inefficient bias toward guaranteed contracts. While acceptable in the past, the shift in the advertising industry demands a mix of guaranteed and non-guaranteed contracts.

Another flaw with the decoupled advertising system is the failure to take advantage of the stores of information available when pricing contracts and allocating advertisements to advertisement placements. For example, the current pricing systems only use advertising information and contract information at a coarse and untargeted level. The failure to mine and use information regarding how advertisement placements may be allocated at a more granular level creates a gap between the price paid for an advertisement placement and the actual value that a contract derives from the advertisements placed.

This failure leads to the inability to provide more refined and targeted advertisements. Increased refinement in targeting allows advertisers to reach a more relevant customer base. The frustration of advertisers moving from broad targeting parameters (e.g., “1 million Yahoo!® Finance users) to more fine-grained parameters (e.g., “100,000 Yahoo!® Finance users from September 2008-December 2008 who are California males between the ages of 20-35 working in the health care industry”) is evident. Unfortunately, the increased refinement and targeting is simply not computationally pragmatic with the current system design.

A key aspect of many problems facing the advertising world is how to efficiently serve advertisements in an optimal way. It is not enough to simply make serving choices-whether serving advertising, information pictures, or anything else—correctly or acceptably. Ideally, advertisements should be served in such a way that the potential for clients (e.g., advertisers) and users are maximized.

Accordingly, there exists a need for more efficient ways to allocate advertisements to advertising placements in a network-based environment.

### SUMMARY OF THE INVENTION

The present application provides methods and systems for creating a delivery allocation plan in a network-based environment. The system and method receive a plurality of advertising contracts, the advertising contracts each specifying a demand and a target, and forecast impression data. The system and method include thereafter construct a bipartite graph from the advertising contracts and the forecast impression data, where the bipartite graph includes one or more supply nodes and one or more demand nodes. The supply nodes representing the forecast impression data and the demand nodes represent advertising contract data. The system and method includes annotating each demand node and calculating a first supply value for each impression. The system and method calculate a first demand value for each contract and a second supply value using the first demand value. The system and method calculate a second demand value using the second supply value and a delivery allocation using the second supply value and the second demand value for each contract.

One embodiment the system and method crate the bipartite graph and annotate each demand node during an offline phase. In another embodiment, the system and method further calculate the first supply value, the first demand value, the second supply value, the second demand value, and the delivery allocation during an online phase. In another embodiment, the system and method annotate each demand node with impression history information. In another embodiment, the system and method guide an advertisement allocation is based on the delivery allocation. In another embodiment, the system and method guide an advertisement allocation based on a probability of impressions determined for each contract using the supply values, demand values, and the delivery allocation.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for creating a delivery allocation plan based on advertising contracts in a network based environment;

FIG. 2 illustrates a flowchart of a method for creating a delivery allocation plan in a network-based environment;

FIG. 3 illustrates a sample output display as generated by the system and method for creating a delivery allocation plan in a network-based environment; and

FIG. 4 illustrates an example of a bipartite graph which may be used as an input for the system and method for creating a delivery allocation plan in a network-based environment.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

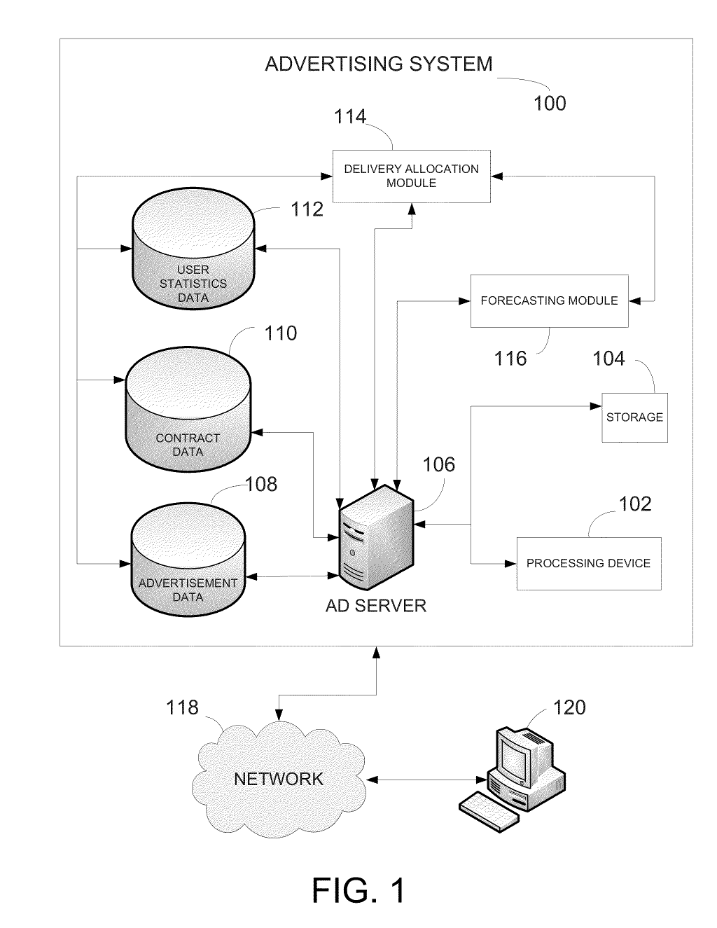

FIG. 1 illustrates an advertising system 100 that includes at least one processing device 102, which may be coupled to a storage device 104 and another processing device, e.g., an ad server 106. The advertising system 100 may further include one or more data stores, such as an advertisement data store 108, a contract data store 110, and a user statistics data store 112. The advertising system 100 may further include a delivery allocation module 114, a forecasting module 116, or a combination thereof. FIG. 1 also illustrates that the advertising system may be coupled to at least one network-based output device 120 over a network 118.

The processing device 102 may be any suitable type of processing device operative to perform processing operations in response to executable instructions, wherein the executable instructions provide for processing operations as described in further detail herein. The storage device 104 may be any suitable type of storage device operative to store the executable instructions on a computer readable medium such that upon transmission to the processing device 102 is operative to perform the processing operations as described herein.

The ad server 106 may be one or more server devices operative to perform server operations, including interfacing with the advertisement data store 108, the contract data store 110, the user statistics store 112, the delivery allocation module 114, and/or the forecasting module 116. The ad server 106 may be further operative to receive and transmit information over a network 118 to the network-based output device 120.

In one embodiment, the ad server 106 may be operative to establish and manage communication among and between a plurality of hardware device, data stores, modules, networks, and network-based outputs. This communication may utilize communication protocols and/or techniques consistent with knowledge of one skilled in the art. In one embodiment, the ad server 106 may be a plurality of server processing devices managing Internet connectivity between users, such as a publicly available Internet search engine, where a user accesses a web site for search request operations.

In another embodiment, the ad server 106 may receive a query from an advertiser with contract terms specifying a target. For example, the query may specify Yahoo!® finance users who are males living in California with an interest in sports and cars. The ad server 106 may return the available advertisement placements for the specified target at a contract price. An advertiser may then book the contract through an interface presented on the network-based output device 120. With the contract stored in the contract data store 110, the ad server 106 may receive an advertisement opportunity over the network 118 from another output device 120. The advertisement opportunity may include information about the user, a URL of the webpage being accessed by the user and the like.

The advertisement data store 108 may include advertising information usable by the advertising system 100 for distributing advertisements to network-based outputs. The advertisement data store 108 may be any number of databases or data storage devices having advertising information therein. Advertising information may include, but is not limited to, an advertisement plan, advertisement content or media, advertisement metadata, advertiser information, publisher information, advertisement placements, advertisement opportunities and advertisement performance analytics. Additionally, the ad server 106 may include additional processing operations or procedures relating to the selection of particular ads and the placement of those ads in network-based outputs, wherein the selection of the particular advertisement may be aided by the processing operations of the processing device 102 as discussed herein using information from any of the data stores 108, 110, 112 or modules 114, 116 in communication with the advertising system.

The contract data store 110 may include contracting information usable by the advertising system 100, the contracting information relating to the terms and conditions for the placement of a number of advertisement placements as requested by the advertiser. The contract data store 110 may be any number of databases or data storage devices having a plurality of contracts, contract requirements, marketing information, etc. Additionally, the ad server 106 may include additional processing operations or procedures relating to the procurement of advertisement placements consistent with the requirements of a given contract. For example, the additional operations of procedures may include receiving a contract time interval and targeting a demographic of users having defined characteristics.

The user statistics data store 112 may include user historic impression information and/or statistical information thereof, e.g., usable by the advertising system 100 in forecasting network traffic, traffic volume for users having defined characteristics, and associated advertising information. The user statistics data store 112 may be any number of databases or data storage devices having user information usable for various purposes, including predicting a volume of users having defined characteristics. Additionally, the ad server 106 may include additional processing operations or procedures relating to the periodic or dynamic updating of user statistics information, the addition of new users, network traffic, demographic and historical information.

The delivery allocation module 114 may include any number of optimizing processes or procedures implemented in software or hardware, or a combination thereof. The delivery allocation module 114 may be operative to receive information from and transmit information to the advertisement data store 108, the contract data store 110, the user statistics data store 112, and the ad server 106. Through the ad server 106, the delivery allocation module 114 may be placed in communication with users on a network-based output 120 through the network 118.

The delivery allocation module 114 may be further operative to be in communication with the forecasting module 116. When in communication with the forecasting module 116, the delivery allocation module 114 may be operative to periodically or dynamically receive forecasting information comprising a number of future advertisement placements or impressions, actual contract information, and/or a prediction of future contracts. The delivery allocation module 114 may be further operative to process information for determining a delivery allocation plan.

In one embodiment, a delivery allocation plan comprises information and/or instruction to guide the allocation and/or distribution of advertisements to available or predicted advertisement placements. A summary of the delivery allocation plan may be transmitted to the ad server 106. The delivery allocation plan may be updated periodically or dynamically on the basis of receiving additional forecasting information or additional information regarding network traffic. Upon receiving an advertisement opportunity, the ad server 106 may calculate the delivery allocation. When used in combination with the forecasting information, information stored in data stores 108, 110, 112, and the delivery allocation plan, the ad server 106 may select a contract and generate a bid for the contract in an effort to procure an advertisement placement presented by an advertisement opportunity.

The forecasting module 116 may include any number of forecasting processes or procedures implemented as software or hardware, or a combination thereof. The forecasting module 116 may be operative to determine the current or future availability of advertisement placements given any number of parameters. Some of those parameters may include user characteristics, marketing information and contract time intervals. In one embodiment, the forecasting module 116 uses a scalable multi-dimensional database indexing technique, such as bit-map indexing, for capturing and storing correlations between any number of user characteristics.

In one embodiment, the delivery allocation module 114 is operative to construct graphs based on contract data from the contract data store 110, user statistics from the user statistics data store 112, and forecast impressions from the forecasting module 116. In one embodiment, the delivery allocation module 114 iteratively calculates dual values for impression and contract data to determine a delivery allocation. In one embodiment, the delivery allocation module transmits the delivery allocation plan to the ad server and the ad server uses the delivery allocation plan to determine which advertisements to use.

The forecasting module 116 may be further operative to determine contention between multiple contracts in the contract data store 110. In one embodiment, the forecasting module 116 may generate a sample set (e.g., impression samples) to determine contention between contracts, as well as the number of contracts that may be satisfied. Forecasting information may be communicated to any number of suitable locations, such as the delivery allocation module 114 or to users through the network 118 for additional processing.

The network 118 may include any communications network (e.g., a wired/wireless LAN/WAN, a cellular network, the Internet, an intranet, a VPN, a PSTN, a VoIP, etc.). The network-based output device 120 may include a general purpose personal computer comprising a processor, transient and persistent storage device, input/output subsystem and bus to provide a communications path between components comprising the general purpose computer. Other network-based outputs are considered to fall within the scope of the present invention including, but not limited to, hand held devices, set top terminals, mobile handsets, PDAs, etc.

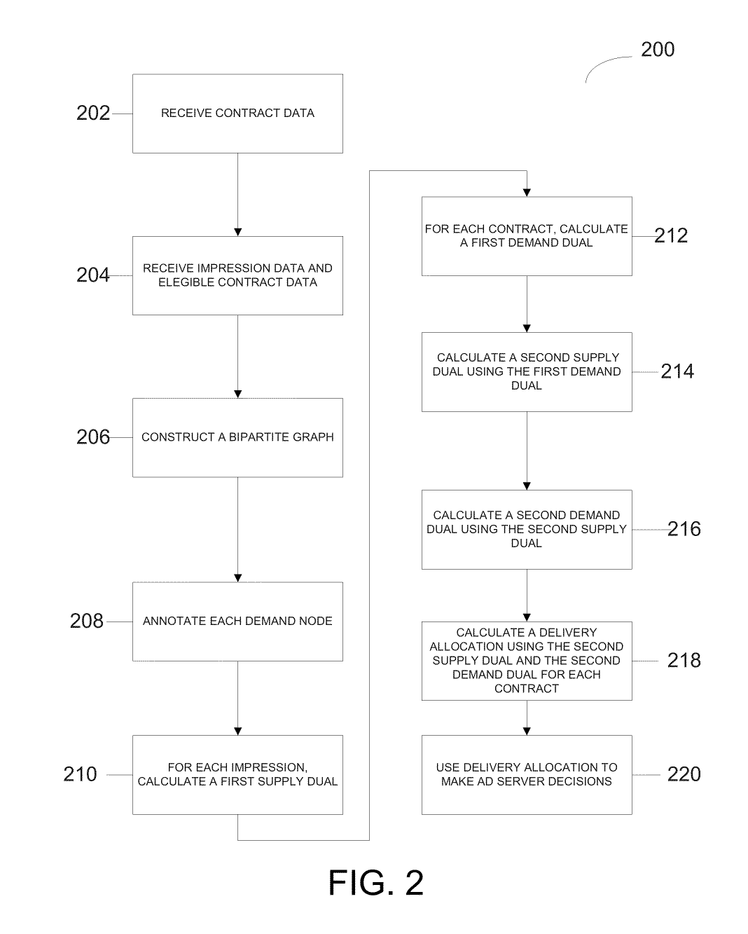

FIG. 2 illustrates a flowchart of one embodiment of a method for creating a delivery allocation plan in a network-based environment. The method may include, step 202, receiving advertising contract data. For example, the contract data may be received from the contract data store 110. The contract data, as described above, includes contracting information relating to terms and conditions for the placement of a number of advertisements as required by the advertiser. The terms and conditions may include a target, e.g., demographic, and a demand (d), e.g., number of guaranteed advertising placements. Various types of guaranteed placements may be specified including a number of impressions, visitors, views, clicks, or other actions. The next step may include, step 204, receiving impression data and eligible contract data. For example, impression data may be received from the forecasting module 116 and eligible contract data may be received from the contract data store 110. Impression data may include information detailing the number of people who look at a specific advertisement. The impression data may be a forecast or actual data. Eligible contract data may be updated contract data, such as new terms or conditions on existing contracts or new contracts.

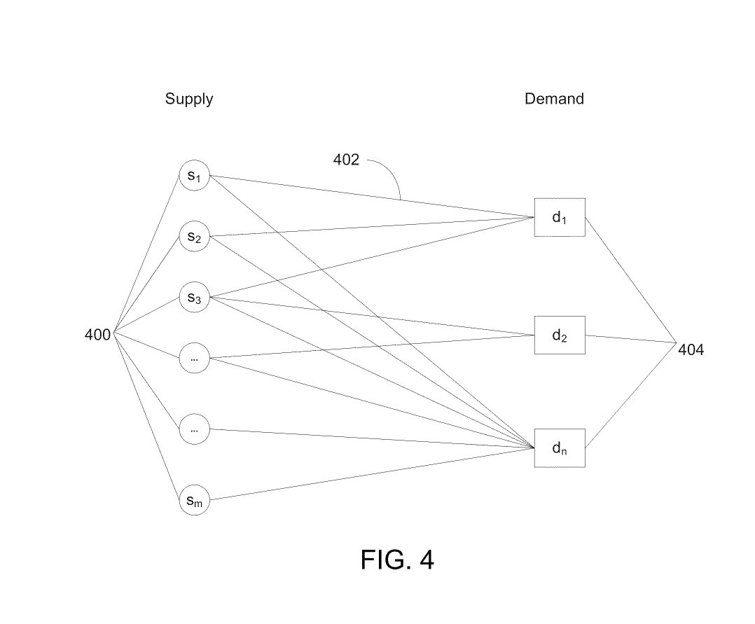

The next step may include, step 206, constructing a bipartite graph using the impression data and the contract data. The bipartite graph may include one or more supply nodes (the advertising placements) and one or more demand nodes (the advertising contracts). In guaranteed display advertising, there are typically a large number of forecast impressions on the supply side together with a number of contracts on the demand side. These contracts specify a target and a number of impressions that should be delivered to the specified target. On one side of the bipartite graph the supply nodes (400) represent impressions and the other side the demand nodes (404) represent contracts. Arcs (402) may be added that connect supply nodes to demand nodes if the impression or impressions that the supply node represents is eligible or matches the target profile for the contract represented by the demand node, as shown in FIG. 4. Further, the number of connections associated with a given demand node are equal to the amount of impressions guaranteed. Supply nodes may represent several impressions each and therefore, each supply node may be labeled with a weight sᵢ, leading to a weighted graph.

An optimal allocation of impressions to contracts should be both feasible and minimize some objective function. The objective generally balances two goals: minimizing penalty and maximizing representativeness. In determining an allocation, assume each demand node/contract j has an associated penalty, pⱼ. Let uⱼ be the under delivery or the number of impressions delivered less than dⱼ. Then the total penalty is Σⱼpⱼuⱼ. Representativeness may be considered as a measure of how close the allocation is to some target. For each impression i and contract j, a target, θᵢⱼ may be defined. For example, the target may be represented as θᵢⱼ=dⱼ/Sⱼ, where Sⱼ=Σ_{i∈Γ(j)}sᵢ, the total eligible supply for contract j. This has the effect of aiming for an equal mix of all possible matching impressions. Γ(j) may be the neighborhood of j, and likewise, Γ(i) may be the neighborhood of i. The non-representativeness for contract j may therefore be represented as the weighted L₂ distance from the target θᵢⱼ and the proposed allocation, xᵢⱼ. Specifically,

$$\frac{1}{2} {\sum }_{i ∈ Γ ( j )} {s}_{i} \frac{{V}_{j}}{{θ}_{ij}} {( {x}_{ij} - {θ}_{ij} )}^{2} ,$$

where Vⱼ is the relative priority of the contract j; a larger Vⱼ means that representativeness is more important. Notice that sᵢ is weighted to account for the fact that some sample impressions have more weight than others. Representativeness may be considered key for advertiser satisfaction. Simply giving an advertiser the least desirable type of users (e.g., three-year-olds with a history of not spending money) or attempting to serve out an entire contract in a few hours decreases long-term revenue by driving advertisers away.

Given these goals, an optimal allocation may be written in terms of a convex optimization problem:

$$\begin{matrix}Minimize \frac{1}{2} {\sum }_{i ∈ Γ ( j )} {s}_{i} \frac{{V}_{j}}{{θ}_{ij}} {( {x}_{ij} - {θ}_{ij} )}^{2} + {\sum }_{j} {p}_{j} {u}_{j} & \\ such that {\sum }_{i ∈ Γ ( j )} {s}_{i} {x}_{ij} + {u}_{j} \geq {d}_{j} {∀}_{j} & ( 1 ) \\ {\sum }_{j ∈ Γ ( i )} {x}_{ij} \leq 1 {∀}_{i} & ( 2 ) \\ {x}_{ij} , {u}_{j} \geq 0 {∀}_{i , j} & ( 3 )\end{matrix}$$

Constraints 1 are called demand constraints. They guarantee that uⱼ precisely represents the total under delivery to contract j. Constraints 2 are supply constraints, and they specify no more than one ad for each impression is served. Constraints 3 are simply non-negativity constraints.

The optimal allocation for the guaranteed display problem is the solution to the above problem, where the input bipartite graph represents the full set of contracts and the full set of impressions. Of course, generating the full set of impressions is impossible in practice. One solution may be to use a sample of impressions that still produces an approximately optimal fractional allocation. The fractions are interpreted as the probabilities that given impressions should be allocated to a given contract. Since there may be billions of impressions, this may lead to a serving that is nearly identical. Although the present application focuses on a solution to the problem noted above, the techniques discussed herein may be extended to more general objectives. For example, a multi-objective model for the allocation of inventory to guaranteed delivery, which combined penalties and representativeness with revenue made on the non-guaranteed display spot market and the potential revenue gained from supplying clicks to contracts.

Although the notion of an optimal allocation may be defined, serving such an allocation presents a different problem. The problem associated with serving may be forecast in two phases: an offline and an online phase. Thus, the next step may include, step 208, annotating each demand node. That is, during an offline phase, each demand node (corresponding to a contract) of the bipartite graph should be annotated with information obtained from previously served impressions. This information may be used to guide the allocation during an online phase. During the online phase, impressions may arrive one at a time. For each impression, a set of eligible contracts are identified using the annotation computed during the offline phase of each returned contract. Using only this information, the system may decide which contract to serve to the incoming impression.

The online allocation is the actual allocation of impressions to contracts given during the online phase. It would be beneficial to produce an online allocation that is as close to optimal as possible. If the input bipartite graph exactly models the future impressions, then the online allocation produced is optimal. If the input bipartite graph is generated by sampling from the future, then the online allocation produced is provably approximately optimal. However, previous solutions simply assumed that an optimal solution may be found during the offline phase. Although this may be true, it is does not address many of the practical concerns that come with solving large-scale non-linear optimization problems.

Obtaining a full solution using traditional methods is usually too slow (and more precise than necessary), while the High Water Mark (HWM) algorithm, although very fast, sacrifices optimality. The HWM algorithm is an algorithm based on a greedy heuristic. This method first orders all the contracts by their allocation order. Here, the allocation order puts the contracts with smaller Sⱼ (e.g. total eligible supply) before contracts with larger Sⱼ. Then the algorithm goes through each contract one after another, trying to allocate an equal fraction from all the eligible ad opportunities. This fraction is denoted ζ for each contract, and corresponds roughly to its demand dual. Contract j is given fraction ζⱼ from each eligible impression, unless previous contracts have taken more than a 1−ζⱼ fraction already. In this case, contract j gets whatever fraction is left (possibly 0).

If there is very little contention (or contract j comes early in the allocation order), then ζⱼ=dⱼ/Sⱼ. This will give exactly the right amount of inventory to contract j. However, if a lot of inventory has already been allocated when j is processed, its ζⱼ value may be larger than this to accommodate the fact that it gets less than ζⱼ for some impressions. Setting ζ=1 will give a contract all inventory that has not already been allocated. This is just in case that there was not enough remaining inventory to satisfy the demand of j.

The present application creates an allocation plan that spans the two previously discussed approaches, while solving the problem of compact serving, while being fast, simple, and robust. That is, if the method for creating an allocation plan, as discussed herein, runs for enough iterations, it will produce the true optimal solution. Moreover, running the method for zero iterations (plus an additional step at the end) produces the HWM allocation. Therefore, precision may easily be balanced with run time. Usually, only ten or twenty iterations of this method will yield remarkably good results. Further, in practice, the method for creating an allocation plan, as discussed herein, is amenable to “warm-starts,” using the previous allocation plan as a starting point.

In one embodiment, the allocation plan is created using optimal duals and converting the duals into a good primal solution. This can be done by extending the simple heuristic HWM to incorporate dual values. Thus, the first thing to do may be to find reasonable duals, followed by converting the duals into good primal solutions. Finding duals generally involves an iterative algorithm. The dual solution will generally improve on each iteration. Repeated iterations converge to the true optimal.

The next step, step 210, may then be to calculate a first supply value for each impression. The dual solution may include a supply value and a demand value. The first supply value is βᵢ in the equation below. During Stage One, the α values are iteratively improved by assuming that the β are correct and solving for the α.

Initialize. Set αⱼ=0 for all j.

Stage One. Repeat until time runs out:

1. For each impression i, find βᵢ that satisfies

Σ_{j∈Γ(i)}gᵢⱼ(αⱼ−βᵢ)=1

If βᵢ<0 or no solution exists, update βᵢ=0.

The next step, step 212, may then be to calculate a first demand value for each contract. To find the first demand value, βᵢ or the first supply value, from the above equation is placed into the below equations and solved for αⱼ or the first demand value. In order to find better β values, it is assumed that a is correct and then solve for β using the equation below. The theorem below shows that this simple iterative technique converges to an optimal solution in polynomial steps.

Theorem 1. Let ε>0, and suppose that Stage One runs for

$$\frac{1}{ɛ} n {max}_{j} \{ {p}_{j} / {V}_{j} \}$$

iterations, producing output α. Then the reconstructed solution generated from α is guaranteed to have an objective value that differs from the optimal by at most εP, where P=Σⱼpⱼdⱼ, the penalty paid for delivering no inventory.

2. For each contract j, find αⱼ that satisfies

$${\sum }_{i ∈ Γ ( j )} {s}_{i} {g}_{ij} ( {α}_{j} - {β}_{i} ) = {d}_{j}$$

If αⱼ>pⱼ or no solution exists, update αⱼ=pⱼ.

The next step, step 214, may then be to calculate a second supply value using the first demand value. Using the first demand value found from the above equation, solve for a second supply value in the equation below. In Stage Two, ζ values are calculated in a way similar to HWM. β values are calculated based on the α values, the first demand value, generated from Stage One. Using these, ζ is calculated to give dⱼ allocation (delivery allocation) to each contract, if possible. Notice that in Stage Two, actual allocation is taken into consideration. Thus, the remaining fraction \tilde{s}ᵢ, cannot be exceeded. Thus, contracts allocated latest may not be able to get the full amount specified by gᵢⱼ, if the fraction taken from impression i is too great.

Stage Two.

1. Initialize \tilde{s}ᵢ=1 for all i.

2. For each impression i, find βᵢ that satisfies

Σ_{j∈Γ(i)}gᵢⱼ(αⱼ−βᵢ)=1

If βᵢ<0 or no solution exists, update βᵢ=0.

The next step, step 216, may be to calculate a second demand value using the second supply value. Using the second supply value βᵢ found from performing the equation above and performing the equation below will produce the second demand value αⱼ. The next step, step 218, may be to calculate a delivery allocation dⱼ using the second supply value βᵢ and the second demand value αⱼ for each contract. The delivery allocation may thereafter be used to make ad server decisions at step 220.

3. For each contract j, in allocation order, do:

(a) Find ζⱼ that satisfies

$${\sum }_{i ∈ Γ ( j )} min \{ {\tilde{s}}_{i} , {s}_{i} {g}_{ij} ( {ζ}_{j} - {β}_{i} ) \} = {d}_{j} ,$$

setting ζⱼ=∞ if there is no solution.

(b) For each impression i eligible for j, update

\tilde{s}ᵢ=\tilde{s}ᵢ−min{\tilde{s}ᵢ,sᵢgᵢⱼ(ζⱼ−βᵢ)}.

Output. The αⱼ (demand value) and ζⱼ (fraction of each eligible impression) for each j. It should be noted that for the second part of Stage Two, a two-pass version is used. In the first pass, ζⱼ is bounded by αⱼ for each j. In the second pass, a second set of ζ values (with no upper bounds) are found and therefore, utilizing any left-over inventory. This is a “truer” allocation than the one produced by Stage One, and gives a slightly better online allocation.

This implementation runs in linear time per iteration corresponding to the number of arcs in the original input bipartite graph.

Since the above output produces two values for each contract j, namely αⱼ and ζⱼ. Given impression i, the α values for eligible contracts are used to calculate the βᵢ value, which is used together with the ζ values to produce the allocation. The equation is shown below.

Input: Impression i and the set of eligible contracts.

1. Set \tilde{s}ᵢ=1 and find βᵢ such that

Σ_{j∈Γ(i)}gᵢⱼ(αⱼ−βᵢ)=1

If βᵢ<0 or no solution exists, set βᵢ=0.

2. For each matching contract j, in allocation order, compute

xᵢⱼ=min{\tilde{s}ᵢ,gᵢⱼ(ζⱼ−βᵢ)} and update \tilde{s}_{i←\tilde{s}}ᵢ−xᵢⱼ.

3. Select contract j with probability xᵢⱼ. (If Σ_{jΓ(i)}xᵢⱼ<1, then there is some chance that no contract is selected.)

Therefore, the advertising system 100 uses an algorithm to generate and/or use compact allocation plans leading to near-optimal serving. The algorithm is scalable, efficient, and has the stop-anytime property, making it useful in time-sensitive applications. This algorithm produces a much better and more robust solution than the simple HWM heuristic. Due to the stop-anytime property, the system 100 can be configured to give the desired tradeoff between running time and optimality of the solution. Furthermore, the system 100 can handle “warm starts,” using a previous allocation plan as a starting point for future iterations. The algorithm used by the system 100 may be easily modified to handle additional goals, such as maximizing revenue in non-guaranteed market or click-through rate of advertisement. The technique also appears to be amenable to other classes of problems involving many users with supply constraints (e.g., each user is shown only one item). Therefore, the algorithm described herein may extend to problems outside of guaranteed display ad delivery.

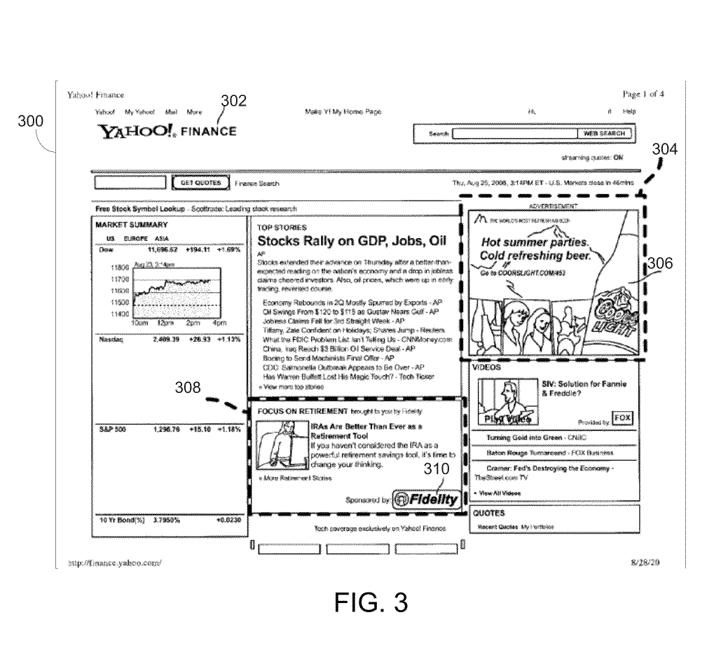

FIG. 3 illustrates a sample output display as generated by the system and method for creating a delivery allocation plan described herein. The sample output display may be generated by the advertising system 100 of FIG. 1 for display on the network-based output device 122 via the network 120. Prior to display, the ad server 106 receives information about a user, recognizes that advertisement opportunities exist, and uses the delivery allocation plan to identify advertisements for placement in the interface.

The output display of FIG. 3 may include a first advertisement placement 304 and a second advertisement placement 308, denoted by the dotted lines. These advertisement placements are directed relative to a user. As the sample output display may suggest, the advertisements 306 and 310 may be placed in advertisement placements presented to users having an interest in finance and sports as defined characteristics. This sample output display generated includes one advertisement from Coors Light® 306 and another sponsored by Fidelity 310, where the advertisement 306 recognizes that the user may choose a beverage for consumption while watching a sporting event and advertisement 310 may entice the user to explore investment opportunities with their company. As such, the output sample screen shot 300 of FIG. 3 illustrates a representative display with advertisements selected based on the characteristics of the user and the fulfillment of corresponding advertisement contracts.

FIG. 4 illustrates an example of the bipartite graph that may be used as an input for the system and method for creating a delivery allocation plan in a network-based environment. On the left side are supply nodes (400) which represent impressions. On the other side are demand nodes (404) which represent contracts. An arc (402) between a given supply node to a given demand node is drawn if the impression that the supply node represents is eligible for the contract represented by the demand node. A supply node may be eligible if it matches a target profile. Further, a demand node may be labeled with a demand which is the amount of impressions guaranteed to the represented contract. In general, supply nodes may represent several impressions each and therefore, a supply node may be weighted.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for creating a delivery allocation plan in a network-based environment, the method comprising:
receiving a plurality of advertising contracts, the advertising contracts each specifying a demand and a target;
receiving forecast impression data;
constructing a bipartite graph from the advertising contracts and the forecast impression data, the bipartite graph comprising one or more supply nodes and one or more demand nodes, wherein the supply nodes represent the forecast impression data and the demand nodes represent the advertising contract data;
calculating a first supply value for each impression;
calculating a first demand value for each contract;
calculating a second supply value using the first demand value;
calculating a second demand value using the second supply value; and
calculating a delivery allocation using the second supply value and the second demand value for each contract.

2. The method of claim 1, further comprising: annotating each demand node during an offline phase.

3. The method of claim 2, wherein calculating the first supply value, the first demand value, the second supply value, the second demand value, and the delivery allocating are performed during an online phase.

4. The method of claim 2, further comprising: annotating each demand node with impression history information.

5. The method of claim 1, further comprising: guiding advertisement allocation decisions based on the delivery allocation.

6. The method of claim 5, wherein the guiding of an advertisement allocation is based on a probability of impressions determined for each contract using the supply values, the demand values, and the delivery allocation.

7. A system for creating a delivery allocation plan based on advertising contracts in a network-based environment, the system comprising:
a computer readable medium having executable instructions stored thereon;
a processing device in communication with the computer readable medium operative to receive the executable instructions therefrom, the processing device, in response to the executable instructions, operative to:
receive contract data from a contract data store;
receive impression data from a user statistics data store;
construct a bipartite graph from the advertising contracts and the forecast impression data;
calculate a first supply value for each impression;
calculate a first demand value for each contract;
calculate a second supply value using the first demand value;
calculate a second demand value using the second supply value; and
calculate a delivery allocation using the second supply value and the second demand value for each contract.

8. The system of claim 7, further comprising: annotating each demand node during an offline phase.

9. The system of claim 8, wherein the calculating of the first supply value, the first demand value, the second supply value, the second demand value, and the delivery allocating are performed during an online phase.

10. The system of claim 7, further comprising: annotating each demand node with previous impression history information.

11. The system of claim 7, further comprising: guiding advertisement allocation decisions based on the delivery allocation.

12. The method of claim 11, wherein the guiding of an advertisement allocation is based on a probability of impressions determined for each contract using the supply values, the demand values, and the delivery allocation.

13. Computer readable media comprising program code that when executed by a programmable processor causes execution of a method for creating a delivery allocation plan based on advertising contracts in a network-based environment, the computer readable media comprising:
program code for receiving a plurality of advertising contracts, the advertising contracts each comprising a demand and a target;
program code for receiving forecast impression data;
program code for constructing a bipartite graph from the advertising contracts and the forecast impression data, the bipartite graph comprising one or more supply nodes and one or more demand nodes, wherein the supply nodes represent the forecast impression data and the demand nodes represent the advertising contract data;
program code for calculating a first supply value for each impression;
program code for calculating a first demand value for each contract;
program code for calculating a second supply value using the first demand value;
program code for calculating a second demand value using the second supply value; and
program code for calculating a delivery allocation using the second supply value and the second demand value for each contract.

14. The system of claim 13, further comprising:
annotating each demand node during an offline phase.

15. The system of claim 14, wherein the calculating of the first supply value, the first demand value, the second supply value, the second demand value, and the delivery allocating are performed during an online phase.

16. The system of claim 14, further comprising: annotating each demand node with previous impression history information.

17. The method of claim 13, further comprising: guiding advertisement allocation decisions based on the delivery allocation.

18. The method of claim 17, the guiding of an advertisement allocation is based on a probability of impressions determined for each contract using the supply values, the demand values, and the delivery allocation.
